(19) United States
(12) Patent Application Publication
(10) Pub. No.: US 2010/0194238 A1
(43) Pub. Date: Aug. 5, 2010

(54) SERIALLY OPERATING MULTI-ELEMENT PIEZOELECTRIC ACTUATOR DRIVER

(76) Inventors: Michael J. Frick, Newbury Park, CA (US); Michael C. Cheiky, Thousand Oaks, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/652,679

(22) Filed: Jan. 5, 2010

Related U.S. Application Data
(60) Provisional application No. 61/144,260, filed on Jan. 13, 2009.

(51) Int. Cl. H02N 2/06

(52) U.S. Cl. 310/317

(57) ABSTRACT

A piezoelectric actuator driving is presented that serially actuates individual piezoelectric elements of a multi-element piezoelectric actuator. One embodiment of the invention features a system comprising (1) a piezoelectric actuator having a plurality of piezoelectric elements; and (2) a current source configured to transmit a plurality of electrical currents to the piezoelectric actuator to actuate a corresponding plurality of the piezoelectric elements; (3) wherein the plurality of electrical currents are configured such that one piezoelectric element reaches a maximum actuation before another piezoelectric element begins actuating.

### CROSS-REFERENCE TO RELATED APPLICATIONS

This application claims priority from U.S. Provisional Patent Application Ser. No. 61/144,260 filed Jan. 13, 2009, which is hereby incorporated herein by reference in its entirety.

### TECHNICAL FIELD

The present invention relates to piezoelectric devices, and more particularly, some embodiments relate to piezoelectric actuators.

### DESCRIPTION OF THE RELATED ART

Piezoelectric actuators comprise a piezoelectric element such as a piezoelectric material (e.g., a crystal, ceramic, or polymer) coupled to electrical contacts to allow a voltage to be applied to the piezoelectric material. Piezoelectric actuators utilize the converse piezoelectric effect to create a mechanical displacement in response to an applied voltage. Such actuators may be used in applications such as machine tools, disk drives, military applications, ink delivery systems for printers, medical devices, precision manufacturing, fuel injection, or any application which requires high precision or high speed fluid delivery.

In most actuators, a single piezoelectric element is used to mechanically actuate the device. While a single-element piezoelectric actuator can precisely control the total actuator displacement, the actual displacement path followed to reach the total displacement is difficult to control. When a driving voltage is applied to a single piezoelectric element, the displacement response is often not linear with respect to the applied voltage. For example, the physical effects of static or dynamic friction, or the nature of the piezoelectric material itself may prevent the actuator from responding linearly according to an applied voltage.

### BRIEF SUMMARY OF EMBODIMENTS OF THE INVENTION

According to various embodiments of the invention, a piezoelectric actuator is presented that serially actuates individual piezoelectric elements of a multi-element piezoelectric actuator.

One embodiment of the invention features a system comprising (1) a piezoelectric actuator having a plurality of piezoelectric elements; and (2) a current source configured to transmit a plurality of electrical currents to the piezoelectric actuator to cause a corresponding plurality of the piezoelectric elements to actuate; (3) wherein the plurality of electrical currents are configured such that one piezoelectric element reaches a maximum actuation before another piezoelectric element begins actuating.

According to some embodiments of the invention, the plurality of electrical currents are further configured such that the piezoelectric element closest to an object to be displaced by the actuator begins actuating first.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 illustrates a piezoelectric actuator having a plurality of piezoelectric elements according to an embodiment of the invention.

FIG. 2 illustrates an example set of actuator currents corresponding to an example desired actuator motion according to an embodiment of the invention.

FIG. 3 is a functional block diagram illustrating a system having a piezoelectric driver coupled to a multi-element piezoelectric actuator according to an embodiment of the invention.

FIG. 4 is a functional block diagram of an example embodiment of a multi-element piezoelectric driver system having a plurality of waveform generators.

FIG. 5 illustrates an example three-element piezoelectric actuator driver according to an embodiment of the invention.

FIG. 6 is a functional block diagram illustrating a digital implementation of a multi-element piezoelectric actuator and driver according to an embodiment of the invention.

FIG. 7 illustrates an exemplary computing module, which may be used to implement various components in particular embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Before describing the invention in detail, it is useful to describe a few example environments with which the invention can be implemented. One such environment comprises a system requiring high speed or high precision fluid delivery. A more particular example is a fuel injector for fuel delivery to a combustion chamber of an engine.

Another such environment is a piezoelectric actuator driver of the type described in U.S. Provisional Patent Application No. 12/686,247, or U.S. Provisional Patent Application No. 12/686,298, each of which is herein incorporated by reference in its entirety. Further environments may employ piezoelectric actuator drives of these types and a fault recovery system of the type described in U.S. patent application Ser. No. 12/652,681, which is hereby incorporated by reference in its entirety. Another environment is system for defining a piezoelectric actuator waveform of the type described in U.S. Provisional Patent Application No. 12/652,674, which is hereby incorporated by reference in its entirety.

Another environment is a fuel injector for fuel delivery to a combustion chamber of an engine. For example, the fuel injector may be a fuel injector for dispensing fuel into a combustion chamber of an internal combustion engine, wherein injector pressure is high enough that the fuel charge operates as a super-critical fluid. An example of this type of fuel injector is disclosed in U.S. Pat. No. 7,444,230, herein incorporated by reference in its entirety.

Another example is a piezoelectrically actuated fuel injector, for example, of the type disclosed in U.S. Provisional Patent Application No. 61/081,326, having a piezo actuated injector pin having a heated portion and a catalytic portion; and a temperature compensating unit; wherein fuel is dispensed into a combustion chamber of an internal combustion engine.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

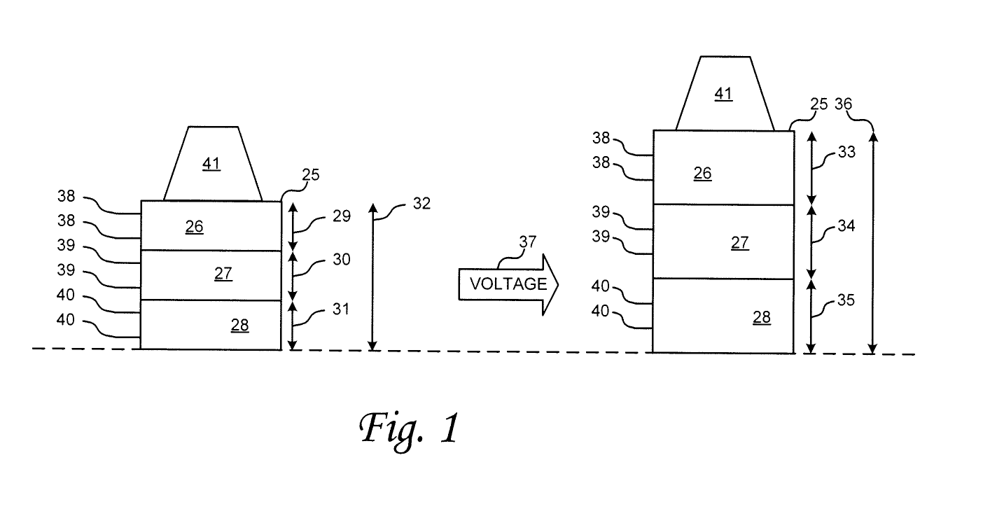

FIG. 1 illustrates a piezoelectric actuator having a plurality of piezoelectric elements according to an embodiment of the invention. Multi-element piezoelectric actuator 25 has a plurality of piezoelectric elements 26, 27, 28 connected in series. Each piezoelectric element has a corresponding rest displacement 29, 30, and 31, resulting in a total rest displacement 32. Piezoelectric elements 26, 27, and 28 may comprise a piezoelectric material, such as a piezoelectric crystal or a piezoelectric ceramic. Piezoelectric elements 26, 27, and 28 further comprise electrical contacts 38, 39, and 40, respectively. When a voltage 37 is applied to the electrical contacts, the individual piezoelectric elements expand to displacements 33, 34, and 35, respectively, resulting in an excited displacement 36 that is greater than the rest displacement 32. Some embodiments may be configured to allow the piezoelectric elements to be operated independently of one another. For example, a voltage could be applied only to contacts 38, causing only piezoelectric element 26 to expand. In further embodiments, the voltage applied to the contacts varies as a function of time, causing the actuator displacement to also vary as a function of time. For example, (a) first, a voltage could be applied to contacts 38, causing the piezoelectric element 26 closest to the object 41 being displaced to expand to a maximum displacement; (b) second, a voltage could be applied to contacts 39, causing the piezoelectric element 27 next closest to the object 41 to expand to a maximum displacement; and (c) third, a voltage could be applied to contacts 40 causing piezoelectric element 28 farthest from the object 41 to expand to a maximum displacement. In further embodiments, the first, second, and third voltages are not applied until after the preceding piezoelectric element has reached its maximum displacement. In some embodiments, the maximum displacement may be a predetermined percentage of the total desired actuator displacement, for example, each element of a four-element actuator might have a maximum displacement of 25% of the total desired actuator displacement. In other embodiments, the maximum displacement may be physical maximum possible for each element preceding the last element to displace, and the remaining displacement distance for the last element. For example, in a three-element actuator, the desired total displacement may be 0.004 inches, and each element may be able to displace 0.0015 inches. Accordingly, the first two elements to actuate would actuate to their maximum lengths of 0.0015 inches, while the third element to actuate would actuate the remaining 0.001 inches. In this example, if the desired total displacement were only 0.003 inches, then only the first two elements would actuate.

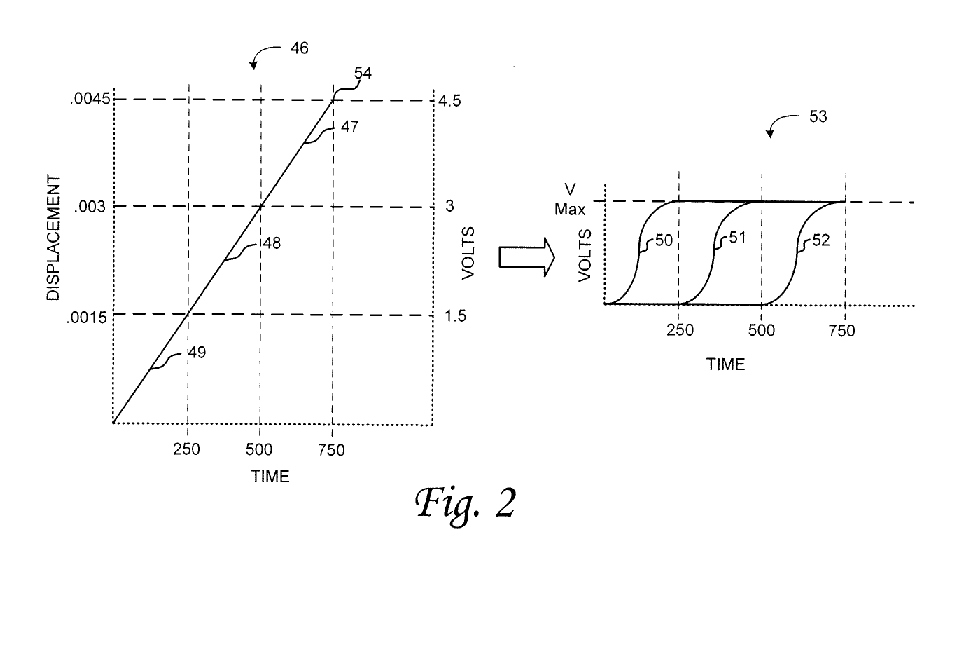

FIG. 2 illustrates an example set of actuator currents corresponding to an example desired actuator motion according to an embodiment of the invention. A multi-element piezoelectric actuator may have a desired displacement behavior 46. For example, the displacement behavior 46 may comprise displacing 0.0045 inches in 750 μs with the displacement path 54 having a substantially constant rate of displacement. In the illustrative example, each piezoelectric element has a maximum possible displacement of 0.0015″ such that three elements of the multi-element piezoelectric actuator are required to achieve the desired displacement. In some embodiments, longevity of the piezoelectric elements may be increased by operating only one piezoelectric element at a time. In further embodiments, operating only one element at a time reduces the risks of placing tension on one of the piezoelectric elements during the contraction of the piezoelectric actuator. Some embodiments may be configured such that an input voltage is proportional to the actuator displacement. For example, 4.5 volts may be required to actuate a distance of 0.0045. In these embodiments, a voltage waveform having substantially the same form as displacement path 54 is provided to a piezoelectric driving system. For example, the voltage waveform may be provided to a piezoelectric driving system as described in U.S. patent application Ser. No. 12/686,247, which is incorporated herein by reference in its entirety.

To operate one piezoelectric element at a time, the waveform 54 is provided to a first channel of the driving system and the portion 49 of the waveform below 1.5 volts is amplified to form driving current 50. Driving current 50 has a voltage waveform that (a) rises to a maximum driving voltage in the first 250 μs and (b) remains at that voltage for the remaining 500 μs. Driving current 50 is provided to the first element of a multi-element piezoelectric actuator, resulting in a displacement of 0.0015″ in the first 250 μs.

Waveform 54 is further provided to a second channel of the driving system. The second channel of the driving system has an offset voltage or clipping point coupled to the amplifier. This offset voltage is set so that the portion 48 of the waveform between 1.5 and 3 volts is amplified to form driving current 51. Driving current 50 has a voltage waveform that (a) remains at 0 volts for the first 250 μs, (b) rises to the maximum driving voltage in the second 250 μs, and (c) remains at that maximum voltage for the remaining 250 μs. Driving current 51 is provided to the second element of a multi-element piezoelectric actuator, resulting in a net displacement of 0.003″ by 500 μs.

Waveform 54 is further provided to a third channel of the driving system. The third channel of the driving system has an offset voltage or clipping point coupled to the amplifier. This offset voltage is set so that the portion 47 of the waveform between 3 and 4.5 volts is amplified to form driving current 52. Driving current 50 has a voltage waveform that (a) remains at 0 volts for the first 500 μs, and (b) rises to the maximum driving voltage in the third 250 μs. Driving current 52 is provided to the third element of a multi-element piezoelectric actuator, resulting in a net displacement of 0.0045″ in 750 μs.

In some embodiments, the required voltage waveform may not be directly proportional to the desired displacement path 54. For example, physical properties of an actuator, such as static and kinetic friction, fluid effects, non-linear piezoelectric material response to voltage, and non-linear amplifier performance, may prevent the actuator from having a linear displacement response to input voltage. In these embodiments, the required voltage waveform to achieve the desired displacement path 54 may be calculated directly from first principles and the desired displacement function. In other embodiments, the voltage waveform may be determined using a method such as the iterative tuning method described in copending U.S. patent application Ser. No. 12/652,674, the contents of which are hereby incorporated by reference in its entirety. In some embodiments, physical or other considerations may prevent an ideal desired actuator behavior from being obtained. In these embodiments, the voltage waveform may be determined to allow the actual actuator behavior to approximate the desired actuator behavior 54, within the constraints of the system. For example, a three-element actuator may not be able to realize a completely linear displacement behavior. The voltage waveform may then be determined to cause the actuator to have a substantially linear displacement behavior. In further embodiments, a particular waveform may be determined for each actuator used in a system. For example, an individual waveform may be determined for each actuator used in an engine fuel injection system. In other embodiments, a waveform may be determined that is applied to a class or group of actuators. For example, a particular waveform may be determined for an entire class of four-element gallium orthophosphate actuators. In these embodiments, a waveform, or plurality of waveforms, may be determined that substantially approximates the desired actuator behavior within the normal range of physical properties of the class or group of actuators.

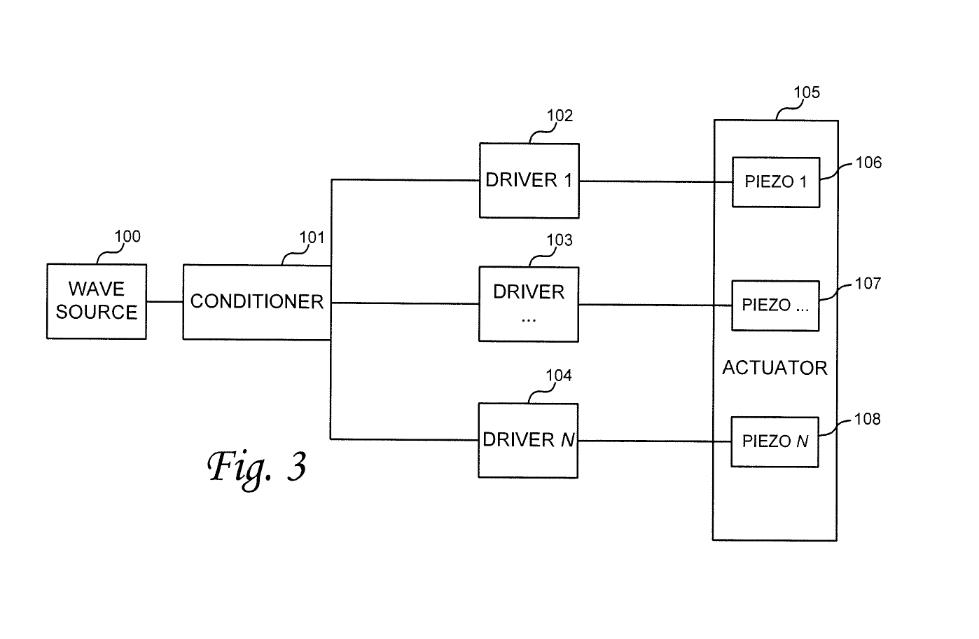

FIG. 3 is a functional block diagram illustrating a system having a piezoelectric driver coupled to a multi-element piezoelectric actuator according to an embodiment of the invention. A wave source 100 is coupled to a conditioner 101 and is configured to provide a waveform to conditioner 101. Wave source 100 may comprise any tool or device used to generate an electrical signal wave, for example an analog waveform generator such as a function generator or an arbitrary waveform generator, or a digital waveform generator. Conditioner 101 is coupled to a plurality of drivers 102, 103, and 104. Conditioner 101 is configured to provide selected portions of the waveform to the plurality of drivers. Conditioner 101 may comprise any tool or device used to apportion or divide a voltage source or waveform, for example a parallel-connected group of offsetting and clipping circuits as described herein, or a digital signal processing implementation of a waveform divider. The plurality of drivers 102, 103, and 104, are coupled to the piezoelectric elements 106, 107, and 108, respectively, of multi-element piezoelectric actuator 105, and are configured to provide the required drive voltages to their respective piezoelectric elements. Drivers 106, 107, and 108, may comprise, for example linear amplifiers or switching amplifiers.

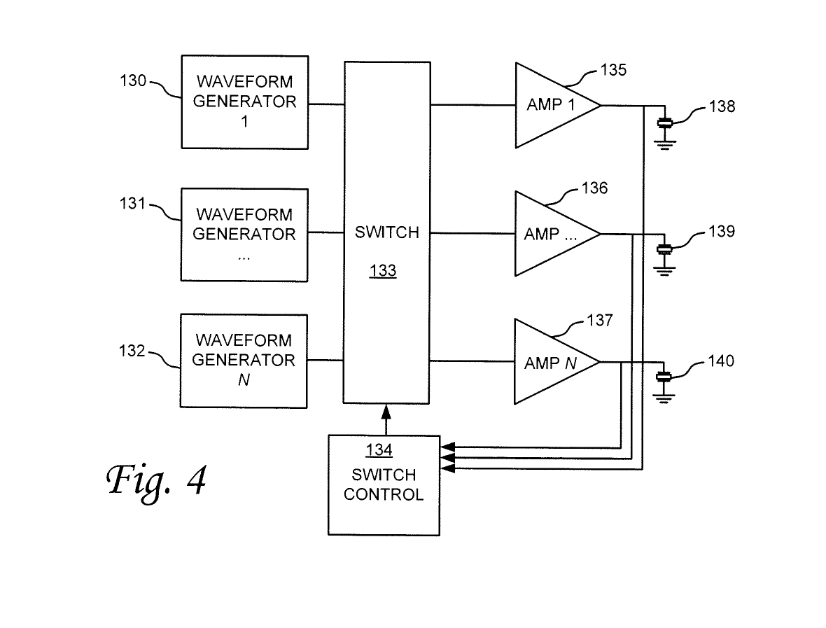

FIG. 4 is a functional block diagram of an example embodiment of a multi-element piezoelectric driver system having a plurality of waveform generators. Plurality of waveform generators 130, 131, 132, are coupled to a switch 133 and are configured generate waveforms for operating piezoelectric elements 138, 139, and 140 of a piezoelectric actuator. Switch 133 is coupled to amplifiers 135, 136, and 137 and switch control module 134. Switch 133 is configured to transmit the waveforms received from the plurality of waveform generators to the various amplifiers as controlled by the switch control 134. Switch control 134 is configured to monitor conditions on the lines connecting amplifiers 135, 136, and 137 to piezoelectric elements 138, 139, and 140. Switch 133 may comprise, for example, an analog switch matrix or a digital implementation thereof coupled to a digital to analog converter and switch control 134 may comprise, for example, a microprocessor programmed to control the switch. Amplifiers 135, 136, and 137 are coupled to corresponding piezoelectric elements 138, 139, and 140 and are configured to receive transmitted waveforms from switch 133 and to amplify them to drive the piezoelectric elements. Amplifiers 135, 136, and 137, may comprise any amplifier, such as a linear or switching amplifier.

Switch 133 and switch control 134 may operate according to the method disclosed in U.S. patent application Ser. No. 12/652,681, the contents of which are hereby incorporated by reference in its entirety, to allow continued operation in the event that one or more of the piezoelectric elements 138, 139, or 140 fail. For example, if the monitored voltage to piezoelectric element 138 were to suddenly drop, switch control 134 could command switch 133 to prevent the waveform from waveform generator 130 from being transmitted to amplifier 135. Or, if the waveform contributed more to a desired actuator behavior, the switch control 134 may use the switch 133 to route the waveform to another amplifier and to cease transmitting a less contributing waveform.

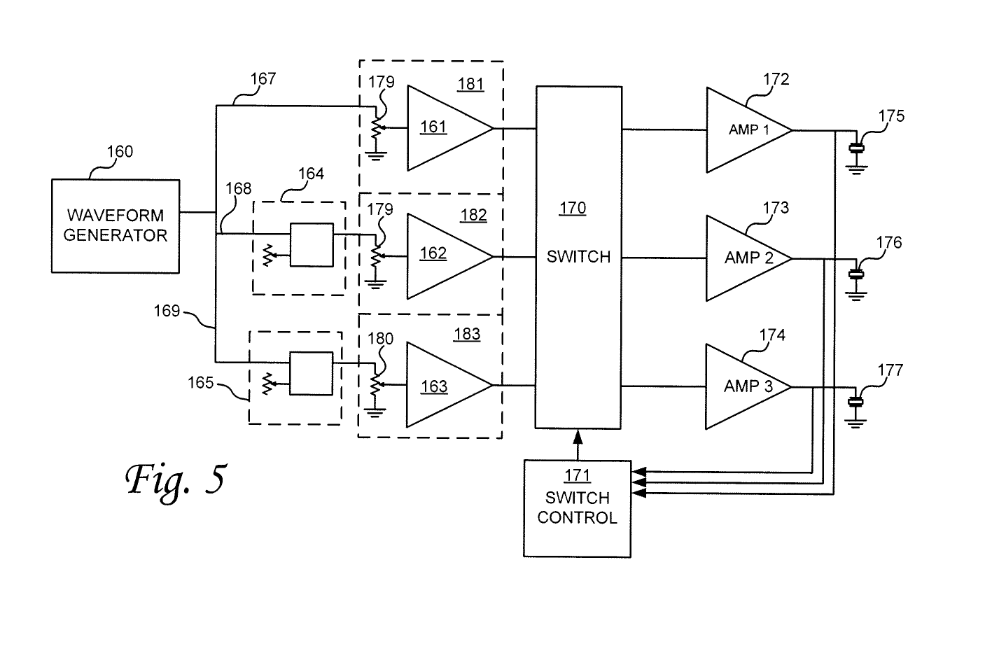

FIG. 5 illustrates an example three-element piezoelectric actuator driver according to an embodiment of the invention. In particular, a waveform generator 160 is configured to provide a waveform for driving a three-element piezoelectric actuator using a waveform division method as described herein. Waveform generator 160 transmits the generated waveform along three parallel channels 167, 168, and 169. The waveform is portioned or divided in the channels, and the waveform portions are amplified using amplifiers 172, 173, and 174 and are used to drive piezoelectric elements 175, 176, and 177.

The first channel 167 comprises an amplifier circuit 181 comprising, for example a potentiometer 178 and an amplifier 161. Amplifier circuit 181 is configured to receive the waveform and to modify it into a waveform portion configured to drive an individual element of the piezoelectric actuator. For example, amplifier circuit 181 may amplify the waveform such that the waveform portion reaches its peak power when the received waveform reaches a predetermined voltage level, for example, approximately ⅓ of its peak voltage. The amplifier circuit 181 may be further configured to allow the predetermined voltage level to be varied depending on the particular actuator application. For example, in a fuel injector application, the predetermined voltage level may be modified, as described in U.S. patent application Ser. No. 12/652,674, to produce the desired engine performance.

The second channel 168 comprises an offset and clip circuit 164, and an amplifier circuit 182. Offset and clip circuit 164 is coupled to the waveform generator and the amplifier circuit 182, and is configured to receive the waveform from the waveform generator and to truncate or clip it by removing the bottom portion of the waveform. Offset and clip circuit 164 may be of the type describe in copending U.S. patent application Ser. No. 12/652,674. In some embodiments, the removed portion corresponds to the wave portion transmitted by the first channel amplifier circuit. For example, if the first channel transmitted a wave portion corresponding to the bottom ⅓ of the waveform, then the clipping level may be set to remove the bottom ⅓ of the waveform. In further embodiments, the clipping level is adjustable, and is configured to be varied depending on the particular actuator application. For example, in a fuel injector application, the clipping level may be modified as described in U.S. patent application Ser. No. 12/652,674, to produce the desired engine performance. Amplifier circuit 182 may comprise, for example, potentiometer 179 and amplifier 162. Amplifier circuit 182 is configured to amplify the clipped waveform so that a portion of the clipped waveform is transmitted to a piezoelectric actuator. For example, if the first channel's waveform portion corresponds to the lower ⅓ of the waveform, and the clipping circuit clipped the bottom ⅓ of the waveform, then the amplifier circuit 182 may amplify the clipped waveform so that the lower ½ of the clipped waveform is transmitted (corresponding to the middle ⅓ of the original waveform). In further embodiments, the amplifier circuit may also be adjusted to amplify different portions of the clipped waveform, according to the actuator's use.

The third channel 169 comprises an offset and clip circuit 165 and an amplifier circuit 183. Offset and clip circuit 165 is coupled to the waveform generator and the amplifier circuit 183, and is configured to receive the waveform from the waveform generator and to truncate or clip it by removing the bottom portion of the waveform. In some embodiments, the removed portion corresponds to the wave portions transmitted by the first and second channels. For example, if the first channel and second channel transmitted wave portions corresponding to the bottom ⅔ of the waveform, then the offset and clip circuit may be configured clip the waveform at ⅔ of its maximum voltage. In further embodiments, the clipping level is adjustable, and is configured to be varied depending on the particular actuator application. For example, in a fuel injector application, the clipping level may be modified as described in U.S. patent application Ser. No. 12/652,674, to produce the desired engine performance. Amplifier circuit 183 may comprise, for example, potentiometer 180 and amplifier 163. Amplifier circuit 183 is configured to amplify the clipped waveform so that a portion of the clipped waveform is transmitted to a piezoelectric actuator. For example, if the first channel and second channel transmitted the lower two portions of the waveform, then the amplifier circuit 183 may amplify the clipped waveform so that the entire clipped waveform is transmitted (corresponding to the upper ⅓ of the original waveform). In further embodiments, the amplifier circuit may also be adjusted to amplify different portions of the clipped waveform, according to the actuator's use.

Switch 170 is coupled to the channels 167, 168, and 169, the output amplifiers 172, 173, and 174, and the switch control 171. Switch 170 is configured to route any input channel 167, 168, or 169 to any output amplifier 172, 173, or 174, or to disable any input channel, for example, by connecting it to ground. Switch 170 may comprise, for example, an analog switch matrix, or a plurality of relays. Switch control 171 is coupled to switch 170 and is configured to monitor the lines connecting the output amplifiers 172, 173, and 174. Switch control 171 is further configured to reroute which waveform portion is transmitted to which output amplifier if the monitored conditions indicate that a piezoelectric elements 175, 176, or 177 has failed. For example, switch control 171 and switch 170 may operate according to the method described in U.S. patent application Ser. No. 12/652,681, to allow the actuator to continue to operate in the event that one or more of the piezoelectric elements 175, 176, or 177 fail. Amplifiers 172, 173, and 174 are configured to receive waveform portions routed through the switch 170 and to drive them to enable operation of piezoelectric elements 175, 176, and 177. Amplifiers 172, 173, and 174, may comprise any power amplifier, for example linear or switching-type amplifiers.

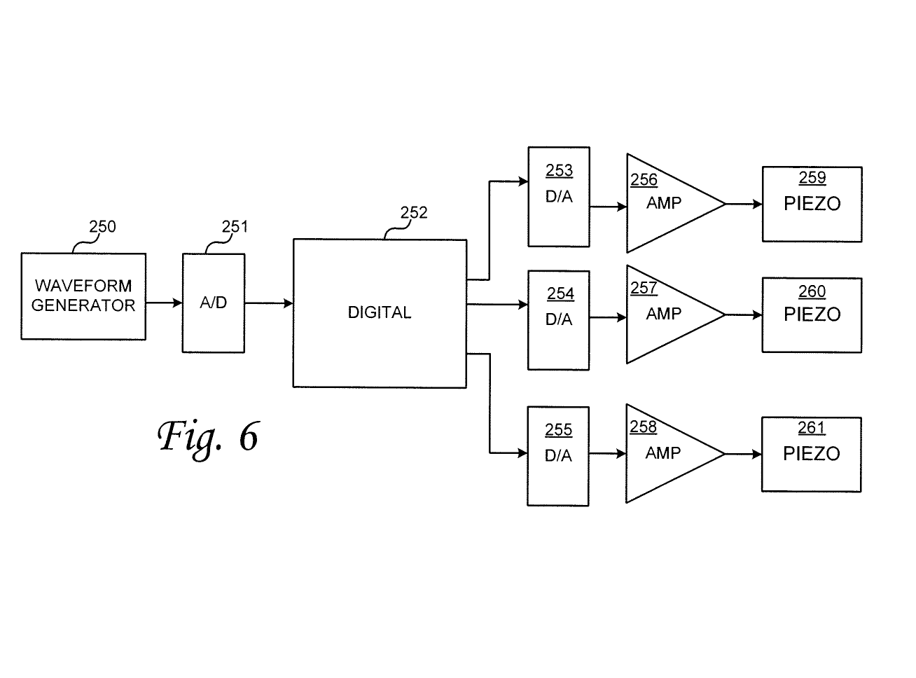

FIG. 6 is functional block diagram illustrating a digital implementation of a multi-element piezoelectric actuator and driver according to an embodiment of the invention. Waveform generator 250 outputs an analog voltage waveform to an analog to digital converter 251. Analog to digital converter 251 outputs the digitally converted waveform to microprocessor 252. Microprocessor 252 is programmed to perform the functions of dividing the digital waveform into digital waveform portions for individual operations of piezoelectric elements 260. Microprocessor is further programmed to output each digital waveform portion to digital to analog converters 253, 254, and 255. Each digital to analog converter 253, 254, and 255 converts its respective digital waveform portion into an analog waveform portion, which is then outputted to power amplifiers 256, 257, and 258. Power amplifiers 256, 257, and 258 amplify the received waveform portions to drive a piezoelectric element and output the amplified waveform portions to piezoelectric elements 259, 260, and 261, respectively. In further embodiments, the functions of waveform generator 250 may be digitally implemented, so that microprocessor 252 may be programmed to produce a digital waveform, or digital waveform portions, directly. In still further embodiments, microprocessor 252 may be configured to monitor the piezoelectric elements 259, 260, and 261, and may be configured to provide fault control, for example through the methods described in U.S. patent application Ser. No. 12/652,681. In yet further embodiments, an integrated circuit embodying digital logic to perform the functions of microprocessor 252 may be used in place of microprocessor 252.

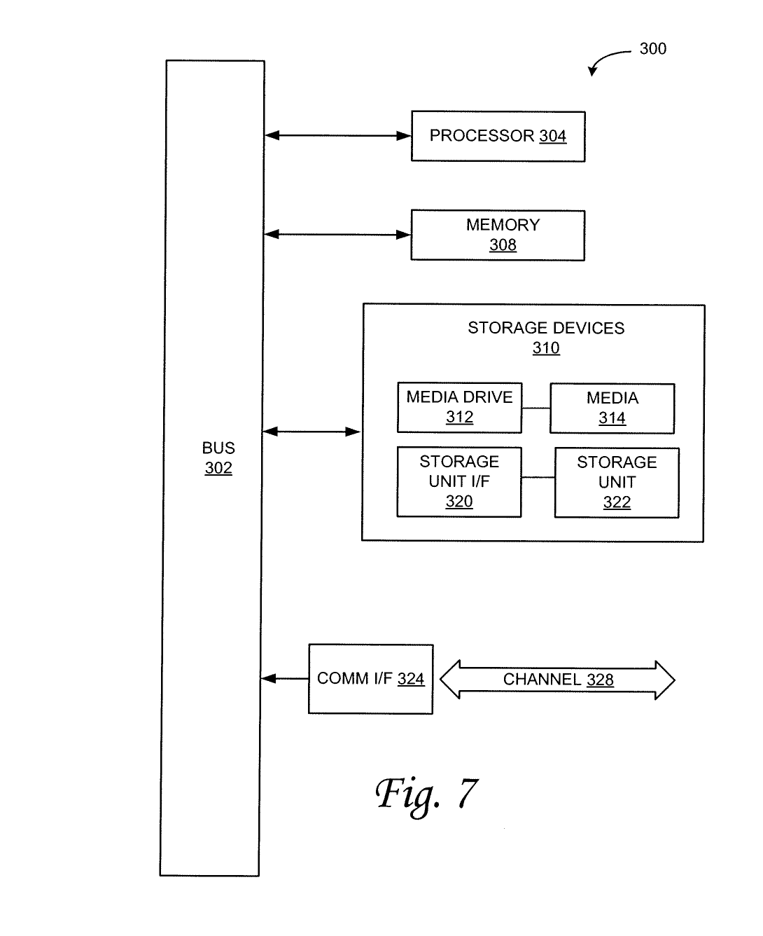

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example-computing module is shown in FIG. 7. Various embodiments are described in terms of this example-computing module 300. After reading this description, it will become apparent to a person skilled in the relevant art how to implement the invention using other computing modules or architectures.

Referring now to FIG. 7, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the example illustrated in FIG. 7, processor 304 is connected to a bus 302, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 302 for storing static information and instructions for processor 304.

The computing module 300 might also include one or more various forms of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD or DVD drive (R or RW), or other removable or fixed media drive might be provided. Accordingly, storage media 314 might include, for example, a hard disk, a floppy disk, magnetic tape, cartridge, optical disk, a CD or DVD, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. These signals can deliver the software and data from memory or other storage medium in one computing system to memory or other storage medium in computing system 300. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to physical storage media such as, for example, memory 308, storage unit 320, and media 314. These and other various forms of computer program media or computer usable media may be involved in storing one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of operating a piezoelectric actuator, comprising:
transmitting a plurality of electrical currents to actuate a corresponding plurality of piezoelectric elements of a piezoelectric actuator;
wherein the plurality of electrical currents are configured such that one piezoelectric element reaches a maximum actuation before another piezoelectric element begins actuating.

2. The method of claim 1, wherein the plurality of electrical currents are further configured such that a piezoelectric element closest to an object to be displaced by the actuator begins actuating first.

3. The method of claim 2, wherein the plurality of electrical currents are further configured such that the piezoelectric elements actuate in sequence according to their distance from the object to be displaced.

4. The method of claim 1, wherein the plurality of electrical currents are further configured such that the piezoelectric actuator follows a predetermined displacement path.

5. The method of claim 4, wherein the predetermined displacement path is a path having a substantially constant rate of displacement.

6. The method of claim 1, wherein the maximum actuation corresponds to a physical maximum possible actuation of the piezoelectric element.

7. The method of claim 1, wherein the piezoelectric actuator has a predetermined displacement distance, the maximum actuation of each piezoelectric actuator is a predetermined percentage of the displacement distance, and the sum of the maximum actuations equals the displacement distance.

8. A piezoelectric driving apparatus, comprising:
a current source configured to transmit a plurality of electrical currents to actuate a corresponding plurality of piezoelectric elements of a piezoelectric actuator;
wherein the plurality of electrical currents are configured such that one piezoelectric element reaches a maximum actuation before another piezoelectric element begins actuating.

9. The apparatus of claim 8, wherein the plurality of electrical currents are further configured such that a piezoelectric element closest to an object to be displaced by the actuator begins actuating first.

10. The apparatus of claim 9, wherein the plurality of electrical currents are further configured such that the piezoelectric elements actuate in sequence according to their distance from the object to be displaced.

11. The apparatus of claim 8, wherein the plurality of electrical currents are further configured such that the piezoelectric actuator follows a predetermined displacement path.

12. The apparatus of claim 11, wherein the predetermined displacement path is a path having a substantially constant rate of displacement.

13. The apparatus of claim 8, wherein the maximum actuation corresponds to a physical maximum possible actuation of the piezoelectric element.

14. The apparatus of claim 8, wherein the piezoelectric actuator has a predetermined displacement distance, the maximum actuation of each piezoelectric actuator is a predetermined percentage of the displacement distance, and the sum of the maximum actuations equals the displacement distance.

15. A system, comprising:
a piezoelectric actuator having a plurality of piezoelectric elements; and
a current source configured to transmit a plurality of electrical currents to the piezoelectric actuator to actuate a corresponding plurality of the piezoelectric elements;
wherein the plurality of electrical currents are configured such that one piezoelectric element reaches a maximum actuation before another piezoelectric element begins actuating.

16. The apparatus of claim 15, wherein the plurality of electrical currents are further configured such that a piezoelectric element closest to an object to be displaced by the actuator begins actuating first.

17. The apparatus of claim 16, wherein the plurality of electrical currents are further configured such that the piezoelectric elements actuate in sequence according to their distance from the object to be displaced.

18. The apparatus of claim 15, wherein the plurality of electrical currents are further configured such that the piezoelectric actuator follows a predetermined displacement path.

19. The apparatus of claim 18, wherein the predetermined displacement path is a path having a substantially constant rate of displacement.

20. The apparatus of claim 15, wherein the maximum actuation corresponds to a physical maximum possible actuation of the piezoelectric element.
